(19) United States
(12) Patent Application Publication
(10) Pub. No.: US 2015/0172946 A1
(43) Pub. Date: Jun. 18, 2015

(54) REMOTE AND LIVE RF NETWORK MEASUREMENT AND OPTIMIZATION

(71) Applicant: MULTIPLE ACCESS TECHNOLOGIES, INC., PLANO, TX (US)

(72) Inventors: YOUNG MIN LEE, ARLINGTON, TX (US); ASIF HASAN, PLANO, TX (US)

(73) Assignee: MULTIPLE ACCESS TECHNOLOGIES, INC., PLANO, TX (US)

(21) Appl. No.: 14/091,350

(22) Filed: Nov. 27, 2013

Related U.S. Application Data
(60) Provisional application No. 61/761,925, filed on Feb. 7, 2013.

(51) Int. Cl. H04W 24/10

(52) U.S. Cl. CPC H04W 24/10

(57) ABSTRACT

An enabling platform is provided where an installed agent (e.g., device-side software) may be installed on a mobile device to decode chipset level information readable on the mobile device. Such readable chipset level information can then be transmitted and/or accessed in real-time via a central server for dynamic, real-time, geo-location for mobile device and network performance enhancement. An important feature of the embodiments of the present invention include the ability to decode and transmit chipset level information from a mobile device in real time so that remote field service data gathering, and local headquarter service assessment and issue resolution, may occur more on a contemporaneous basis, permitting faster issue assessment and resolution, which benefits the telecommunications providers and their customers.

### RELATED APPLICATION

This application claims priority to provisional patent application U.S. Ser. No. 61/761,925 filed on Feb. 7, 2013, the entire contents of which is herein incorporated by reference.

### BACKGROUND

The embodiments herein relate generally to a platform for expediting the diagnosis and resolution of telecommunication services issues with real-time communication between remote field engineers and local diagnostic engineers using the transmission of chipset level data in real time.

Conventional RF (radio frequency wireless communication) measurement and optimization process lacks remote, real time feedback mechanism where the issues can be identified and fixed in real time remotely. Further, these conventional approaches may require clunky equipment, highly trained or experienced personnel leading to high labor cost, and long turn-around time before any optimization options may be identified. Currently, with conventional approaches, RF network data collected in the field has to be physically delivered or uploaded to a remote computer for analysis by an engineer in the office. There is no option for remote live viewing of RF network data as it is measured and collected by the engineer out in the field. Current solutions are expensive, burdensome, lack mobility, and involve multiple pieces of hardware, which requires additional time and resources to set up. Improvements to the measurement, evaluation and optimization of the performance of RF systems are desirable. The conventional approach requires longer turnaround time since the office engineer has to wait for the RF network data to be uploaded or physically delivered to the office. With multiple pieces of hardware involved, solutions currently available have more chances of inaccurate readings, malfunctions, etc.

### SUMMARY

Embodiments and applications of the present invention comprise an enabling platform where an installed agent (e.g., device-side software) on a mobile device is configured to decode chipset level information readable on the mobile device. Such readable chipset level information can then be transmitted and/or accessed in real-time via a central server for dynamic, real-time, geo-location for mobile device and network performance enhancement. An important feature of the embodiments of the present invention include the ability to decode and transmit chipset level information from a mobile device in real time so that remote field service data gathering, and local headquarter service assessment and issue resolution, may occur more on a contemporaneous basis, permitting faster issue assessment and resolution, which benefits the telecommunications providers and their customers.

Embodiments of the present invention comprise a platform provided to facilitate the real-time transmission of surface level and chipset level data collected by a remote computerized device (e.g., a mobile smart phone) to a local computerized device (e.g., a desktop computer), where the remote computerized device comprises a downloadable application corresponding to the platform, and the local computerized device comprises a downloadable application or installable software also corresponding to the platform, whereby the platform is configured to manage the real-time transmission of the collected data in streaming fashion either periodically pursuant to an established frequency of transmission or upon the request of the local computerized device. In one embodiment, the platform comprises a remote computerized device configured to collect and transmit—in real-time streaming fashion—surface level and chipset level data reflective of telemetry associated with an ambient RF telecommunications service. The local computer can receive the real-time streaming data collected by the remote device when requested or periodically based upon a pre-established frequency. Embodiments of the present system may also comprises a main or central server configured to store the platform software so that functionality of the platform is performed manually and/or automatically, where the main server is configured to be in wired or wireless electronic communication with the local device and the remote device to permit and facilitate transfer therebetween.

Applications of the present invention may also comprise methods of facilitating the real-time transmission of surface level and chipset level data collected by a remote computerized device to a local computerized device. In one embodiment, the method may comprise providing a platform configured to manage the real-time transmission of the collected data in streaming fashion either periodically pursuant to an established frequency of transmission or upon the request of the local computerized device. In some embodiments, the method comprises installing a device-side agent on a mobile device, where the device-side agent is configured to permit wireless data transmission to a central server, and collecting telecommunication service telemetry remotely through the exposure of the mobile device with the device-side agent to the telecommunication service telemetry. The methods may also comprise decoding and transmitting in real-time surface level and chipset level data reflective of telemetry associated with the telecommunications service, and receiving via the central server the real-time surface level and chipset level data collected by the remote mobile device, either when requested by the a user of the central server, or periodically based upon a pre-established frequency. By providing such a methodology, applications of the present invention comprise assessing the data transmitted in real-time via the local device to the central server in order to permit telecommunication service assessment, quality, and/or issue resolution, thereby more quickly improving and/or restoring any non-functioning or poorly functioning aspects of the telecommunications service, including assessing the absence of service in specific geographic locations.

### BRIEF DESCRIPTION OF THE FIGURES

The detailed description of some embodiments of the invention will be made below with reference to the accompanying figures, wherein like numerals represent corresponding parts of the figures.

FIG. 1 shows a schematic view of one embodiment of the present invention.

### DETAILED DESCRIPTION OF CERTAIN EMBODIMENTS

The RF system monitoring, analysis and optimization solution presented by embodiments and methods of the present invention enable real time feedback mechanisms with remote live monitoring and remote control. The measured and collected RF data does not have to be uploaded and viewed at a later time by the engineer in the office. RF data may be streamed from a smart phone or other portable telecommunications device (i.e., mobile device) through the inventive software described herein and can be viewed live remotely from computers with Internet connection or within a private or public network anywhere in the world while a field engineer is walking, driving or otherwise moving through an area of interest to measure and collect the RF network data.

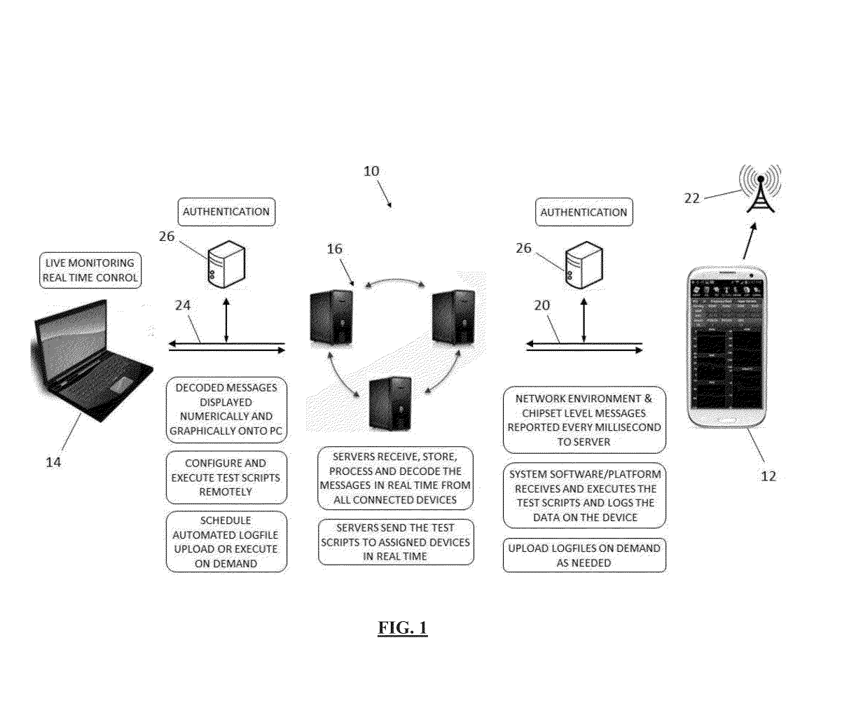

Referring to FIG. 1, in one embodiment 10 for example, device-side software (e.g., a downloadable application) may be installed on a mobile telecommunications device 12. Computer-side software may be installed on a system engineer workstation 14. Server-side software may be installed on a web server 16 with all three software functionality configured to permit all three devices to communicate with each other. In one embodiment, the device-side software may communicate with the computer-side software using server-side software. The web server 16 comprises memory sufficient to store and manage data collected and transmitted from the mobile device to the web server. The connection may be established through TCP/IP 20, where the mobile device comprises a valid data/internet connection via 2G, 3G, 4G networks 22, for example. A file server may be employed that functions as a log file (collected data) management server. The servers together may comprise essentially the back-end operations of embodiments of the present invention. In certain embodiments, the central server comprises part of a back-end server architecture that is configured to enable synchronization with one ore more remote mobile devices in real time, taking advantage of the cloud economics and architecture to connect with any mobile device running the device-side installed agent. The back-end server architecture may facilitate instantaneous visualization and display of real-time key metrics of engineering performance accessed from the remote mobile device(s), such as but not limited to, Ec/Io, RSCP, BLER, and/or PSC for 2G, 3G, or 4G devices that have the device-side software/utility installed.

In some embodiments, multiple server functions are each performed by a plurality of servers working together, as shown by example in FIG. 1. In other embodiments, such server functionality is performed by a single central server. In either case, the mobile device 12 (and thereby the remote field engineer) is in communication with the web server 16. Meanwhile, the local system engineer (i.e., an engineer tasked with assessing data and/or resolving technical issues detected by the real-time transmission of surface level and chipset level data) and his/her computerized device 14 is also in communication with the web server 16 via a public or private network or via the Internet 24. The user interface may be through the processing and display of real-time and stored data on the hard drive of the user's computer, and/or through a web-based application supported by and/or associated with the web server. Where desired, and in many cases preferably, embodiments of the present invention comprises an authentication utility feature 26 whereby communications between the mobile device 12 and the web server 16, as well as the communications between the local computer 14 and the web server 16, are processed via the authentication utility to ensure secure communications.

The device-side software on the mobile telecommunications device may be configured to measure and record RF network data that may be stored on the device. Such data may include not only surface level data, but chipset data as well. Both the surface and chipset level data can be viewed in real time during collection stage using the computer-side software through live-streaming of data from the device-side software on the mobile device. The data may be received by the server, translated and then displayed in numerical, graphical, and mapped formats on the computer-side software for the user to identify and address RF issues. The above process can be carried out on multiple mobile devices, and/or on one or more local computerized devices, simultaneously. Log files (measurement data) stored on the mobile devices can be transferred in real-time or uploaded via schedule. Log files can be replayed, or used to generate reports for further analysis.

In embodiments of the present invention, it is preferably that the computer-side software loaded onto the local computer with internet or network connection to the web server be configured to permit the local computer user to control certain activity and data collection by the mobile device by way of the device-side software remotely, and monitor the RF network data live in real time. The collected RF data on the mobile device with the device-side software, may be collected and/or stored as log files, which can then be remotely transferred, using the local system. All RF tests or measurements may be user-initiated, either in real-time, or through a scheduling mechanism. The RF test initiation can be done on-site by using the mobile device with device-side software, or may be initiated remotely from anywhere in the world by a system engineer at his or her work station (i.e., the local computer with the computer-side software. As indicated above, all or some of the multiple server components can reside in a single physical server. The need for having multiple servers can be eliminated.

In operation, one application of the present invention may be carried out by a field engineer moving (walking or driving) through an area (indoor or outdoor) served by an RF telecommunications service with his or her mobile device loaded with the device-side software running on the mobile device. A local system engineer located anywhere in the world using a computer with the computer-side software loaded and an active internet connection can connect to the mobile device remotely and execute various tests remotely to monitor and collect RF network data. According to the system engineer's observations of the network data streamed live from the mobile device in real time, recommendations can be made to the field engineer to fix any network issues.

In at least one example of empirical testing of the invention, the applicant was hired by AT&T® to do a pre-drive analysis and optimization for a golf course prior to a major PGA event. A field engineer with a mobile device loaded with an embodiment of the platform system described herein drove around the golf course while the system engineers in the home office analyzed, in real time, the various RF parameters of the nearby antennas that were serving the golf course. The system engineers were able to remotely start/stop tests on the mobile device from the office as desired to view the telecommunications network being assessed. By viewing the device's received parameters in real time through the local desktops, the system engineers were able to identify problem sectors that were swapped (pointing at the wrong directions). There was no need to email/upload the log data and process it in the office in order to reschedule the tower crew and bring the field engineer back again for a re-drive. The technician, tower crew and the office engineers were able to communicate and work in conjunction to resolve the issue in real time using an embodiment of the present invention, resulting in significant reduction of time and cost over prior techniques.

In one application, embodiments of the present invention may be employed to enhance and expedite radio access network engineering services. Other applications are contemplated, including emergency communications (e.g., 911) for public safety, and device and network performance for understanding the mobile user experience in granular detail. It is contemplated that applications of some embodiments of the present invention may comprise origination and/or termination of calls from the central server in order to run user tests ranging from voice communication capability (including but not limited to retainability and accessibility) to data communication capability (including but not limited to ftp, http, https, ping, smtp/email, video on demand, multi-radio access bearer, etc.). It is contemplated that embodiments of the inventive platform may comprises analytics tool that may be used to report live data with real time data feed from the various software elements. Examples include single site verification, pre-integration call tests, site shakedown tests, throughput tests, verification and validation tests, network benchmark testing, device testing and certification, neighbor verification and change validation, and automated customer troubleshooting.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A platform for facilitating the real-time transmission of surface level and chipset level data collected by a remote computerized device, where the transmission is made from the remote device to a local computerized device, the remote device comprising a downloadable application corresponding to the platform, and the local device comprising downloadable or installable software also corresponding to the platform, whereby the platform is configured to manage the real-time transmission of the collected data in streaming fashion either periodically pursuant to an established frequency of transmission or upon the request of the local device, the platform comprising:
a remote computerized device configured to collect and transmit in real-time streaming fashion surface level and chipset level data reflective of telemetry associated with an ambient RF telecommunications service;
a local computerized device configured to receive real-time streaming data collected by the remote computerized device when requested or periodically based upon a pre-established frequency; and
a main server configured to store at least part of the platform software so that functionality of the platform is performed manually and/or automatically, where the main server is configured to be in wired or wireless electronic communication with the local device and the remote device to permit and facilitate transfer therebetween,
whereby the platform permits users at the local computerized device site to direct activities of users of the remote computerized device to resolve issues associated with the ambient RF telecommunications service more quickly, thereby improving and/or restoring any non-functioning or poorly functioning aspects of the telecommunications service, including assessing the absence of service in specific geographic locations.

2. The platform of claim 1, wherein the platform is configured for providing radio access network engineering services.

3. A method of facilitating the real-time transmission of surface level and chipset level data collected by a remote computerized device to a local computerized device, where the method comprises providing a platform configured to manage the real-time transmission of the collected data in streaming fashion either periodically pursuant to an established frequency of transmission or upon the request of the local computerized device, the method comprising:
installing a device-side agent on a mobile computerized device, the device-side agent configured to permit wireless data transmission to a central server;
collecting telecommunication service telemetry remotely through the exposure of the mobile device with the device-side agent to the telecommunication service telemetry;
decoding and transmitting in real-time surface level and chipset level data reflective of telemetry associated with the telecommunications service;
receiving via the central server the real-time surface level and chipset level data collected by the remote mobile device, either when requested by a local user whose local computerized device is in communication with the central server periodically or based upon a pre-established frequency, the central server being configured to store at least part of the platform software associated with the device-side agent so that functionality of the platform is performed manually and/or automatically by the central server; and
installing a computer-side program corresponding to the platform software on the local computerized device to permit such device's user to assess the data transmitted in real-time in order to permit telecommunication service assessment, quality, and/or issue resolution, thereby more quickly improving and/or restoring any non-functioning or poorly functioning aspects of the telecommunications service, including assessing the absence of service in specific geographic locations.
